(19) United States
(12) Patent Application Publication
(10) Pub. No.: US 2018/0004841 A1
(43) Pub. Date: Jan. 4, 2018

(54) System and method for retrieving a signature on a secondary device using a device request

(71) Applicant: Thien Pham, Lacey, WA (US)

(72) Inventor: Thien Pham, Lacey, WA (US)

(73) Assignees: Synergex Group, Greenwhich, CT (US); Wayne Taylor, Chandler, AZ (US); Pham Holdings, Lacey, WA (US)

(21) Appl. No.: 15/201,566

(22) Filed: Jul. 4, 2016

(51) Int. Cl. G06F 17/30; H04L 29/08

(52) U.S. Cl. CPC G06F 17/30864; H04L 67/1002

(57) ABSTRACT

System and method for retrieving a signature on a secondary device using a device request.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to two computer programs that work in conjunction to capture a signature. The first computer program is the requesting program that runs on any device that is connected to the Internet, such as a Smart TV, laptop computer, desktop computer, mobile device, or similar device. The second program is the capture program that runs on any device that can capture a signature drawn on the device using the movement of a computer mouse, finger, or stylus, or select a digital file from device memory. The requesting program starts and creates a transaction request for the user and asks the user to open his/her mobile device and run the capture program. The requesting program waits a certain amount of time before it ends. During such wait time, if the user does not successfully capture a signature using the capture program on the secondary device, the requesting program times out and ends. If the user created a signature on the capture program, the capture program stores the capture signature to database. Once the requesting program knows that there is a signature, the requesting program retrieves the captured signature from database and ends.

### BACKGROUND OF THE INVENTION

On certain devices that run a software application that requires signing your signature, it is difficult or impossible to sign your signature because the device lacks the necessary hardware or it is difficult to use. For example, a website that wants a user to sign his/her signature and the device only has a computer mouse can prove to be a very difficult task to accomplish. If you are able to draw with a computer mouse, it may not represent your signature the way you sign on paper; therefore, it is difficult to prove that the signature is your signature. There are extreme rare situations where a user is an expert at using the computer mouse to sign his/her signature, then, the signature can be proven to be the signature of the user.

Another example is a Smart TV, which does not have a computer mouse or any pointing device to draw on the screen. In this example, a secondary device capable of capturing the movement of the computer mouse, finger, or stylus is needed to draw a signature is needed.

What is needed is a method for using a secondary device with signature capture capability for signing using a stylus, finger, or any pointing device to draw a signature that represents the user's signature or select a digital file that represents the user's signature and stores it to database server.

### BRIEF SUMMARY OF THE INVENTION

In a typical application, a user is asked to sign his/her signature but the host device does not have the necessary hardware or is difficult to use. The application on the host device gives the user an option to sign using a secondary device that has signature capture capability or be able to select a digital file that represents his/her signature from device memory. First, the requesting program presents to the user the option to sign with a secondary device. Once the user selects the signing with the secondary device, the requesting program creates a device request, displays a notification telling the user how to sign using a secondary device capable of capturing the movement of a computer mouse, finger, or stylus or be able to select a digital file that represents the user's signature from device memory. The user then runs the capture program on the secondary device and signs his/her signature. The user can also select a digital file that represents his/her signature from device memory. Once the signature is capture, the capture program stores the captured signature to database. The requesting program constantly checks the status of the device request and if the status of the device request changes and there is a captured signature, the requesting program retrieves the captured signature from database server and ends.

### BRIEF DESCRIPTION OF THE SEVERAL VIEWS OF THE DRAWING

FIG. 1 illustrates an exemplary environment for capturing a signature using a secondary device in a network environment.

FIG. 2 illustrates the method for creating a device request, checking the device request status equal to 1, retrieving the captured signature, and ending the program.

FIG. 3 illustrates the method for capturing a signature and/or selecting a digital file that represents the signature and storing it to database server.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

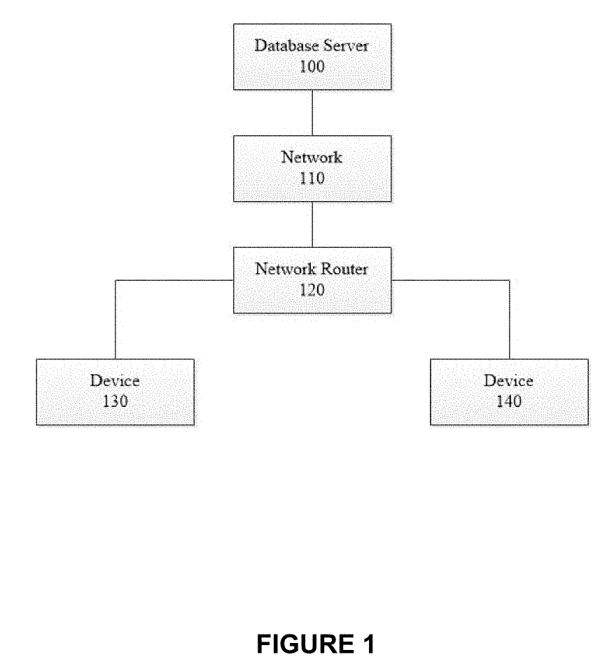

FIG. 1 illustrates an exemplary environment in which the requesting program runs on the device 140. Device 140 is coupled to database server 100 via the network router 120 and the network 110. The signature capture program runs on device 130 and is coupled to database server 100 via the wireless router 120 and the network 110.

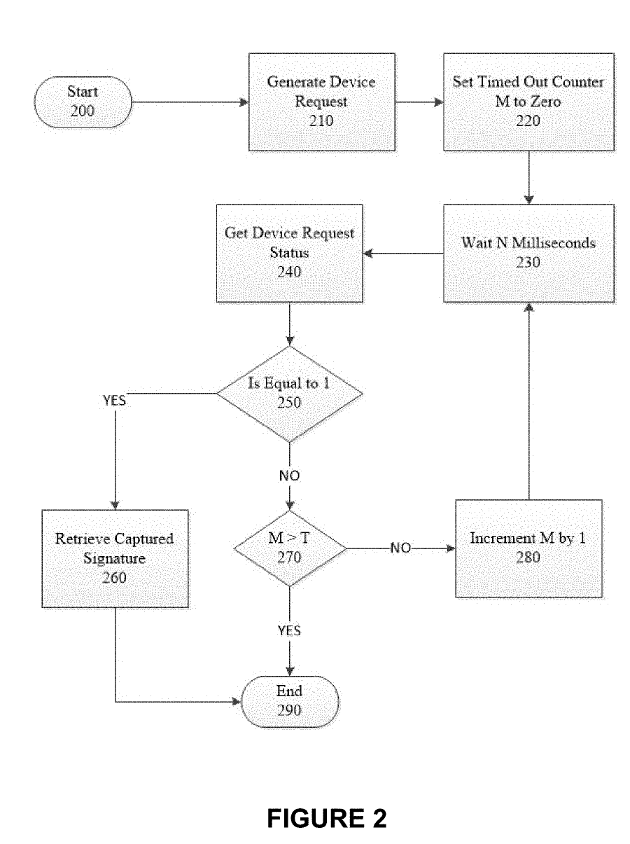

FIG. 2 illustrates the method for creating a device request, checking the device request status equal to 1, retrieving the captured signature, and ending the program. The program starts at Step 200. The program then continues to Step 210, where the program generates a device request consisting of the current date and time, status of the request, IP Address of the device, unique passcode, and unique identifier of the device request and stores it to database server 100. The program then continues to Step 220. At Step 220, the program sets the timed out counter M to zero. The program then continues to Step 230. At Step 230, the program waits N milliseconds, where N is greater than or equal to 1. Once the program completes waiting for N milliseconds, the program continues to Step 240. At Step 240, the program connects to database server 100 to retrieve the device request status of Step 210 using the device request unique identifier of Step 210. The program then continues to Step 250, where it checks the device request status retrieved at Step 240 is equal to 1. If the device request status retrieved at Step 240 is equal to 1, the program continues to Step 260. At Step 260, the program connects to database server 100, retrieves the captured signature that was stored to database server 100 at Step 325 using the device request unique identifier as the identifier, and continues to Step 290. At Step 290, the program ends. If at Step 250, the device request status retrieved at Step 240 is not equal to 1, the program continues to Step 270. At Step 270, the program checks the timed out counter M of Step 220 is greater than T. T is greater than or equal to 1. If M of Step 220 is greater than T, the program continues to Step 290 where the program ends. If at Step 270, M is less than or equal to T, the program continues to Step 280. At Step 280, the program increments M by 1 and continues to Step 230.

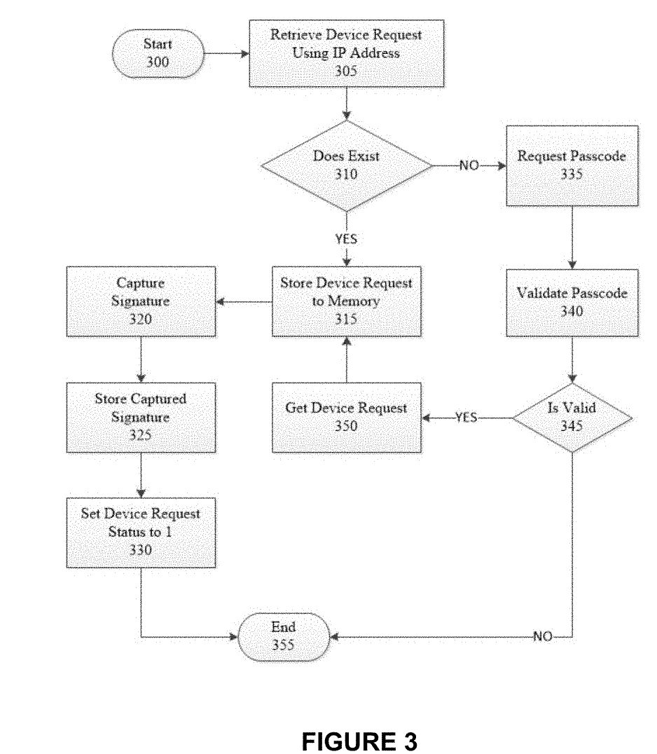

FIG. 3 illustrates the method for capturing a signature and/or selecting a digital file that represents the signature and storing it to database server 100. The capture program on device 130 starts at Step 300 and continues to Step 305. At Step 305, the program connects to the database server 100 and retrieves the device request using its IP Address that is pulled from the network router 120. The program then continues to Step 310. At Step 310, if there is a device request that matches the IP Address, the program continues to Step 315 where it stores the device request retrieved from Step 305 to device memory and the program continues to Step 320 where it asks the user to draw his/her signature using a computer mouse, finger, or stylus or select a digital file that represents the user's signature from device memory. Once a signature is captured at Step 320, the program continues to Step 325, where it connects to the database server 100 and saves the signature using the device request unique identifier that was stored to memory at Step 315. The program then continues to Step 330, where it connects to database server 100 and updates the device request status to 1 and proceeds to Step 355 where the program ends.

If at Step 310, the program is unable to retrieve the device request, the program continues to Step 335 where it asks the user for a passcode. A passcode is an alphanumeric string. Once the user enters the passcode, the program continues to Step 340. At Step 340, the program validates the passcode by connecting to database server 100 and proceeds to Step 345. At Step 345, if the passcode is valid, the program continues to Step 350. At Step 350, the program connects to database server 100 and retrieves the device request using the passcode as the identifier and proceeds to Step 315. If at Step 345, the passcode is not valid, the program continues to Step 355, where the program ends.

Several embodiments are specifically illustrated and/or described herein. However, it will be appreciated that modifications and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for retrieving a signature on a secondary device by generating a device request comprising the steps of:
(a) generating a device request;
(b) storing it database server;
(c) checking the device request status equal to 1 using the device request unique identifier at Step (a);
(d) retrieving a captured signature from database server using the generated device request information at Step (a) if the device request status is equal to 1.

2. The method of claim 1, wherein the device request consists of the current date and time, status, IP Address, unique passcode, and unique identifier

3. A method for using an IP Address or unique passcode to retrieve a device request before initiating the capturing of a signature and storing it to database server comprising the steps of:
(a) retrieving device request using an IP Address;
(b) retrieving device request using a unique passcode;
(c) storing device request to device memory;
(d) capturing a signature;
(e) storing captured signature to database server using device request unique identifier that was stored at Step (c);
(f) connecting to database server and updating the device request status to 1 using device request unique identifier that was stored at Step (c).

4. The method of claim 3, wherein the captured signature is a signature generated by the movement of a computer mouse, finger, or stylus or a digital file from device memory.

5. A system for retrieving a signature using a secondary device comprising:
(a) a network environment;
(b) a network router with unique IP address;
(c) a device that has no signature collection capability or is difficult to use as a signature collector;
(d) a device that has signature collection capability;
(e) a storage medium to store plurality of device requests and signatures in a database.
